(19) United States
(12) Patent Application Publication
(10) Pub. No.: US 2026/0370242 A1
(43) Pub. Date: Nov. 19, 2026

(54) RADIO FREQUENCY FRONT-END SYSTEM

(71) Applicant: Skyworks Solutions, Inc., Irvine, CA (US)

(72) Inventor: Anand Raghavan, Middleton, WI (US)

(21) Appl. No.: 19/677,481

(22) Filed: May 14, 2026

Related U.S. Application Data
(60) Provisional application No. 63/805,827, filed on May 14, 2025.

(51) Int. Cl. H04B 1/00; H04B 1/44; H04L 5/14

(52) U.S. Cl. CPC H04B 1/0057; H04B 1/44; H04L 5/14

(57) ABSTRACT

A radio frequency front-end includes a first module and a second module each configured to provide radio frequency communication paths including at least one transmit path for each of first, second, and third bands, and at least three receive paths for each of the first, second, and third bands. The first module and the second module have at least three antenna ports, an antenna switch connected between the radio frequency communication paths and the at least three antenna ports, and at least three multiplexers each configured to split a corresponding combined receive signal provided by the antenna switch into separate receive signals for the first band, the second band, and the third band.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57 in their entirety.

### BACKGROUND

Embodiments relate to electronic systems, and in particular, to radio frequency electronics. Radio frequency (RF) communication systems can be used for transmitting and/or receiving signals of a wide range of frequencies. For example, an RF communication system can be used to wirelessly communicate RF signals in a frequency range of about 30 kHz to 300 GHz, such as in the range of about 400 MHz to about 7.125 GHz for Frequency Range 1 (FR1) of the Fifth Generation (5G) communication standard, in the range of about 24.250 GHz to about 71 GHz for Frequency Range 2 (FR2) of the 5G communication standard, or in the range of about 7.125 GHz to about 24.25 GHz for Frequency Range 3 (FR3).

Examples of RF communication systems include, but are not limited to, mobile phones, tablets, base stations, network access points, customer-premises equipment (CPE), laptops, and wearable electronics.

### SUMMARY

With new services and frequency bands coming online in the 6-8 GHz spectrum across cellular and connectivity radios, there is an increasing need for highly integrated wireless front-ends designed for high performance and to support a rich set of features. There is also a demand to manage the antenna count, component count, cost/area, routing and overall design complexity. There is also an increasing need for enhanced radio frequency reception processing, whether for enhancing data rates, or to combat poor radio propagation in challenging environments.

In some aspects, the techniques described herein relate to a radio frequency front-end system including: a first module and a second module each configured to provide radio frequency communication paths including at least one transmit path for each of a first band, a second band, and a third band, and at least three receive paths for each of the first band, the second band, and the third band, the first module and the second module each further including at least three antenna ports, an antenna switch connected between the radio frequency communication paths and the at least three antenna ports, and at least three multiplexers each configured to split a corresponding combined receive signal provided by the antenna switch into separate receive signals for the first band, the second band, and the third band; first, second, and third antennas connected to the at least three antenna ports of the first module; and fourth, fifth, and sixth antennas connected to the at least three antenna ports of the second module.

In some aspects, the techniques described herein relate to a radio frequency front-end system wherein the first band, the second band, and the third band are time division duplex bands.

In some aspects, the techniques described herein relate to a radio frequency front-end system wherein each of the at least three multiplexers is a separately packaged device.

In some aspects, the techniques described herein relate to a radio frequency front-end system wherein each of the at least three multiplexers is a triplexer.

In some aspects, the techniques described herein relate to a radio frequency front-end system wherein each of the at least three multiplexers includes one or more acoustic filters.

In some aspects, the techniques described herein relate to a radio frequency front-end system further including a third module and a fourth module each configured to provide at least one transmit path and at least one receive path for at least a fourth band, a seventh antenna connected to the third module, and an eighth antenna connected to the fourth module.

In some aspects, the techniques described herein relate to a radio frequency front-end system wherein the first band, the second band, and the third band are wide area network (WAN) bands, and the fourth band is a local area network (LAN) band.

In some aspects, the techniques described herein relate to a radio frequency front-end system wherein the first band, the second band, and the third band are cellular bands n77, n79, and n104, and the fourth band is a WiFi band.

In some aspects, the techniques described herein relate to a radio frequency front-end system wherein the first module, the second module, the third module, and the fourth module are separately packaged modules.

In some aspects, the techniques described herein relate to a radio frequency front-end system wherein the first module and the second module are each configured to provide at least one transmit path and at least three receive paths for each of the first band, the second band, the third band, and a fifth band, the at least one transmit path for the third band and the fifth band being shared, and the at least three receive paths for the third band and fifth band being shared.

In some aspects, the techniques described herein relate to a radio frequency front-end system wherein the first module and the second module are further configured to provide at least one receive path for a sixth band.

In some aspects, the techniques described herein relate to a radio frequency front-end system wherein the first band, the second band, third band, and the fifth band are cellular bands, and the sixth band is an ultra-wideband.

In some aspects, the techniques described herein relate to a radio frequency front-end system wherein the third module is coupled to the first module, and further configurable to route a signal received in the third band to the first module, and the fourth module is coupled to the second module, and further configurable to route a signal received in the third band to the second module.

In some aspects, the techniques described herein relate to a radio frequency front-end system wherein the third module is coupled to the first module, and further configurable to route a signal received in the third band to the first module, and the fourth module is coupled to the second module, and further configurable to route a signal received in the third band to the second module.

In some aspects, the techniques described herein relate to a radio frequency front-end module including: radio frequency communication paths including at least one transmit path for each of a first band, a second band, and a third band, and at least three receive paths for each of the first band, the second band, and the third band; at least three antenna ports; an antenna switch connected between the radio frequency communication paths and the at least three antenna ports; and at least three multiplexers each configured to split a corresponding combined receive signal provided by the antenna switch into separate receive signals for the first band, the second band, and the third band.

In some aspects, the techniques described herein relate to a radio frequency front-end module wherein the radio frequency front-end module is a multi-chip module contained in a module packaging.

In some aspects, the techniques described herein relate to a radio frequency front-end module wherein each of the at least three multiplexers is a separately packaged device.

In some aspects, the techniques described herein relate to a radio frequency front-end module wherein each of the at least three multiplexers is a triplexer including one or more acoustic filters.

In some aspects, the techniques described herein relate to a radio frequency front-end module wherein the first band, the second band, and the third band are wide area network (WAN) bands.

In some aspects, the techniques described herein relate to a mobile device including: a transceiver; a radio frequency front-end including a first module and a second module each configured to provide radio frequency communication paths including at least one transmit path for each of a first band, a second band, and a third band, and at least three receive paths for each of the first band, the second band, and the third band, the first module and the second module each further including at least three antenna ports, an antenna switch connected between the radio frequency communication paths and the at least three antenna ports, and at least three multiplexers each configured to split a corresponding combined receive signal provided by the antenna switch into separate receive signals for the first band, the second band, and the third band; first, second, and third antennas connected to the at least three antenna ports of the first module; and fourth, fifth, and sixth antennas connected to the at least three antenna ports of the second module.

### BRIEF DESCRIPTION OF THE DRAWINGS

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of an example dual connectivity network topology.

FIG. 5A is a schematic diagram of one example of a communication system that operates with beamforming.

FIG. 5B is a schematic diagram of one example of beamforming to provide a transmit beam.

FIG. 5C is a schematic diagram of one example of beamforming to provide a receive beam.

FIG. 6A is a schematic diagram of a front-end system in accordance with certain embodiments.

FIG. 6B is a schematic diagram of the front-end system of FIG. 6A in a different mode.

FIG. 6C is a schematic diagram of a front-end system in accordance with another embodiment.

FIG. 6D is a schematic diagram of the front-end system of FIG. 6C in a different mode.

FIG. 7A shows other embodiments of Wi-Fi modules that can be incorporated in a front-end system such as the front-end system of FIG. 6A-6B.

FIG. 7B shows other embodiments of Wi-Fi modules that can be incorporated in a front-end system such as the front-end system of FIG. 6C-6D.

FIG. 8 is a schematic diagram of one embodiment of a mobile device.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and plans to introduce Phase 2 of 5G technology in Release 16 (targeted for 2020). Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

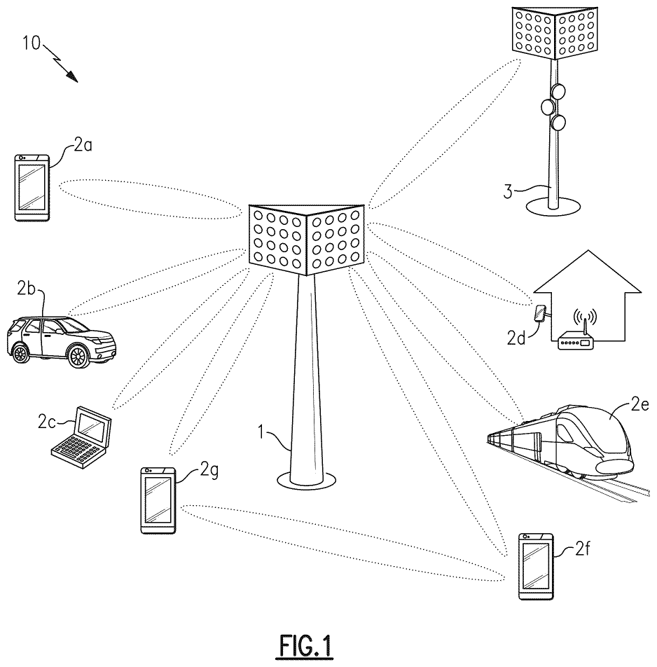

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz. Cellular user equipment can communicate using beamforming and/or other techniques over a wide range of frequencies, including, for example, FR2-1 (24 GHz to 52 GHZ), FR2-2 (52 GHz to 71 GHZ), and/or FR1 (400 MHz to 7125 MHz).

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

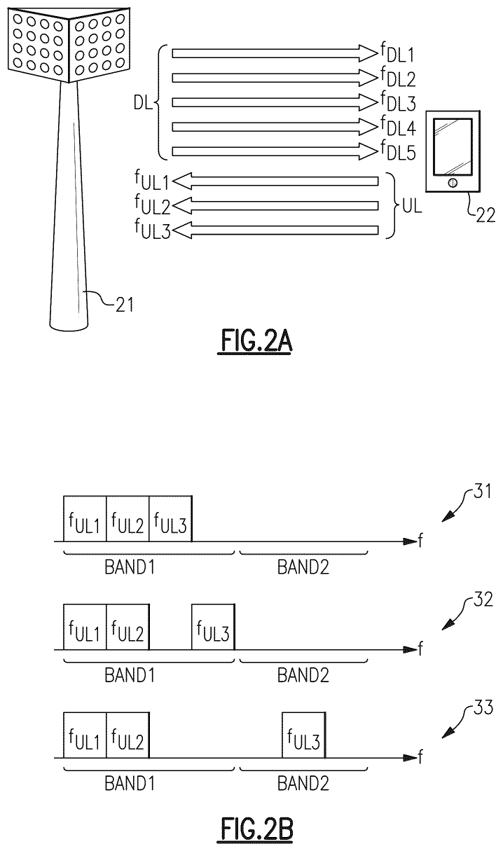

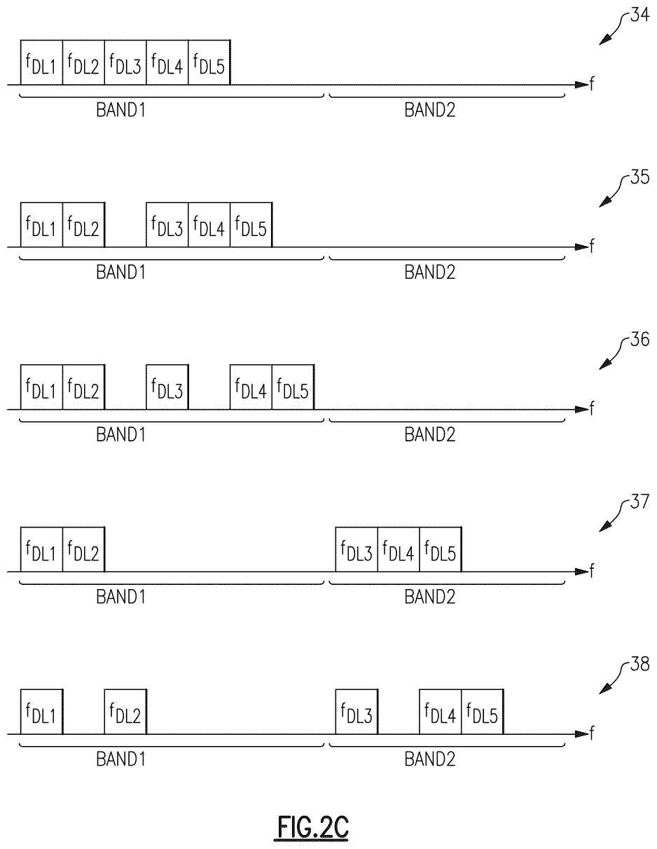

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers fUL1, fUL2, and fUL3. Additionally, the downlink channel includes five aggregated component carriers fDL1, fDL2, fDL3, fDL4, and fDL5. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier fUL1, a second component carrier fUL2, and a third component carrier fUL3. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers fUL1, fUL2, and fUL3 that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers fUL1, fUL2, and fUL3 that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers fUL1 and fUL2 of a first frequency band BAND1 with component carrier fUL3 of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier fDL1, a second component carrier fDL2, a third component carrier fDL3, a fourth component carrier fDL4, and a fifth component carrier fDL5. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink. Furthermore, NR-U can operate on top of LAA/eLAA over a 5 GHz band (5150 to 5925 MHz) and/or a 6 GHz band (5925 MHz to 7125 MHz).

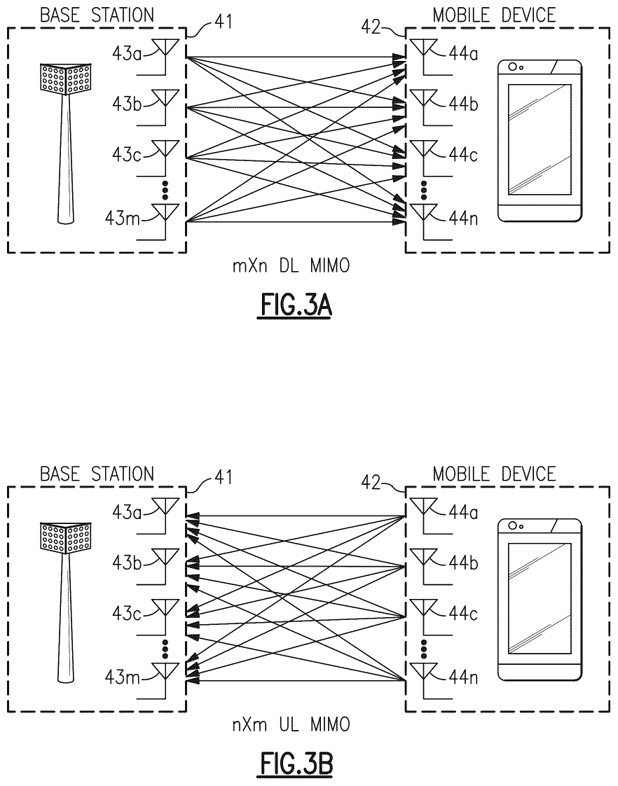

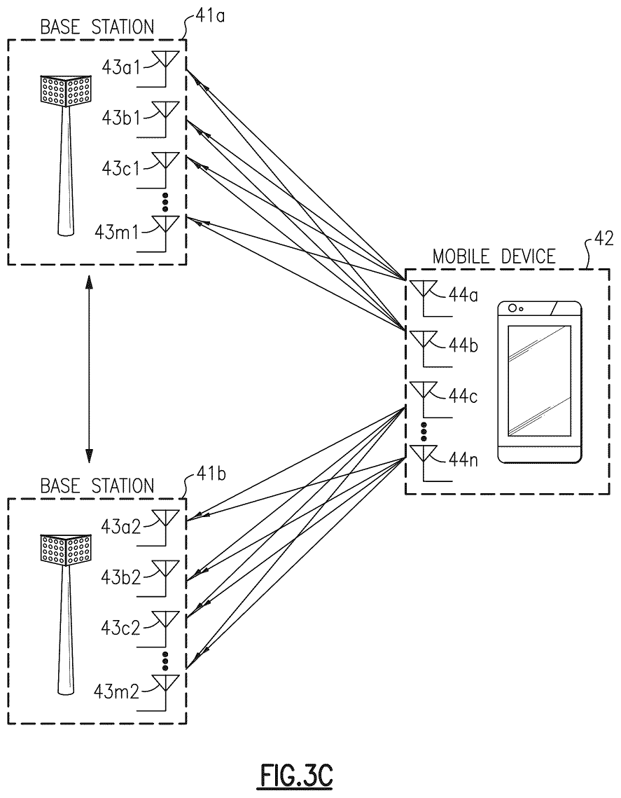

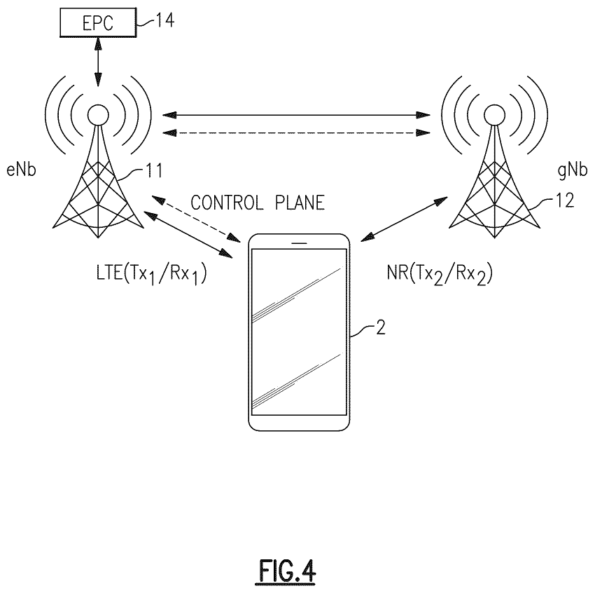

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additional a first portion of the uplink transmissions are received using M antennas 43a1, 43b1, 43cl, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

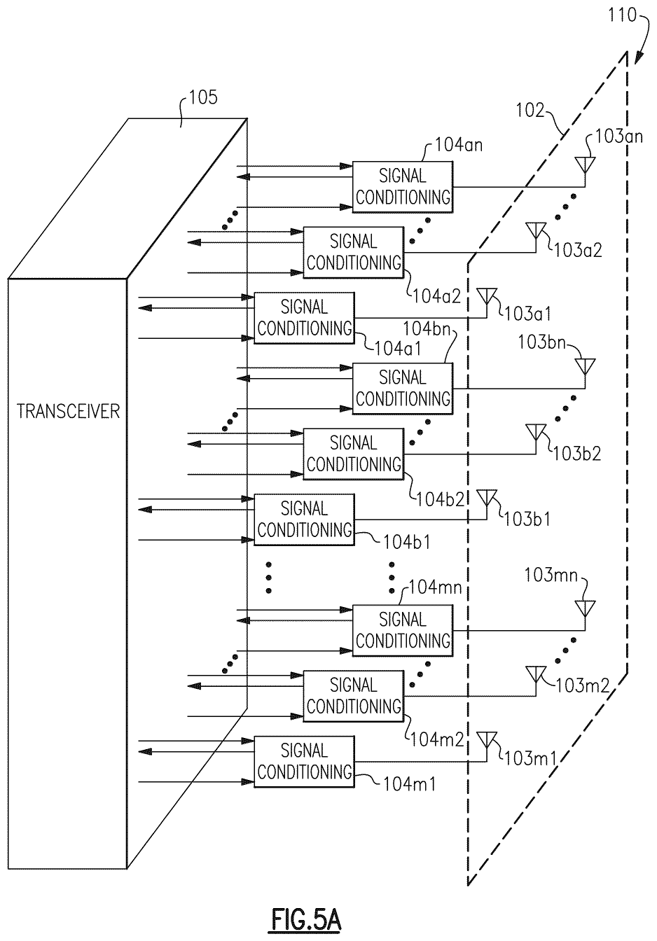

FIG. 4 is a schematic diagram of an example dual connectivity network topology. This architecture can leverage LTE legacy coverage to ensure continuity of service delivery and the progressive rollout of 5G cells. A UE 2 can simultaneously transmit dual uplink LTE and NR carrier. The UE 2 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 1. The eNB 11 can provide a connection with a core network, such as an Evolved Packet Core (EPC) 14. The gNB 12 can communicate with the core network via the eNB 11. Control plane data can be wireless communicated between the UE 2 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 2. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G and 5G carriers being simultaneously transmitted from a UE. Transmitting both 4G and 5G carriers in a UE, such as a phone, typically involves two power amplifiers (PAS) being active at the same time. Traditionally, having two power amplifiers active simultaneously would involve the placement of one or more additional power amplifiers specifically suited for EN-DC operation. Additional board space and expense is incurred when designing to support such EN-DC/NSA operation.

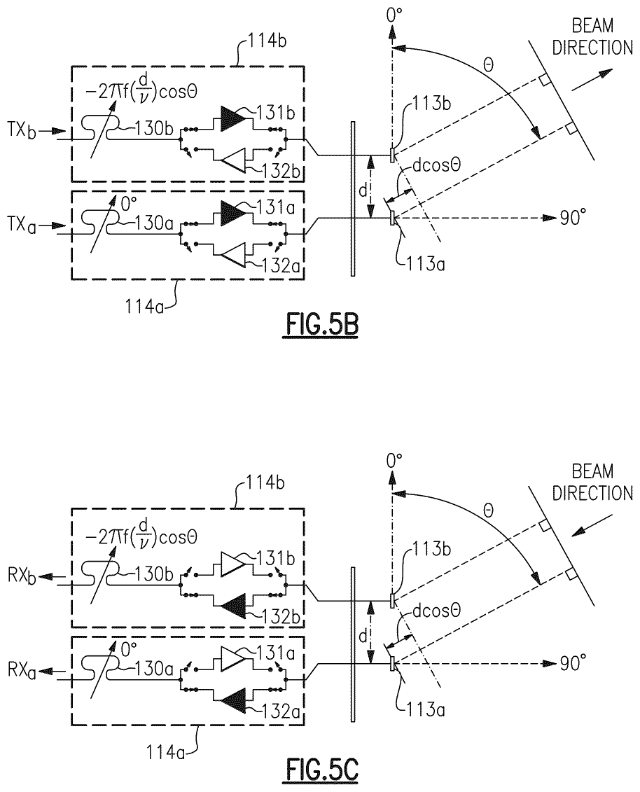

FIG. 5A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal propagates for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle θ can be achieved. For example, when the first phase shifter 130a has a reference value of 0°, the second phase shifter 130b can be controlled to provide a phase shift of about −2πf(d/v)cos θ radians, where f is the fundamental frequency of the transmit signal, d is the distance between the antenna elements, v is the velocity of the radiated wave, and π is the mathematic constant pi.

In certain implementations, the distance d is implemented to be about ½λ, where λ is the wavelength of the fundamental component of the transmit signal. In such implementations, the second phase shifter 130b can be controlled to provide a phase shift of about −π cos θ radians to achieve a transmit beam angle θ.

Accordingly, the relative phase of the phase shifters 130a, 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal to −2σf(d/v) cos θ radians to achieve a desired receive beam angle θ. In implementations in which the distance d corresponds to about ½λ, the phase difference can be selected to about equal to −π cos θ radians to achieve a receive beam angle θ.

Although various equations for phase values to provide beamforming have been provided, other phase selection values are possible, such as phase values selected based on implementation of an antenna array, implementation of signal conditioning circuits, and/or a radio environment.

In cellular networks, such as 5G networks, sounding reference signal (SRS) features can be enabled to determine channel qualities of a communication link between user equipment (UE) (for example, a wireless device such as a mobile phone) and a base station. SRS symbols are transmitted on uplink and processed by the network to estimate the quality of the wireless channel at different frequencies. For instance, the SRS symbols transmitted by the UE can be used by the base station to estimate the quality of the uplink channel for large bandwidths outside the assigned frequency span to the UE.

For the case of 4×4 MIMO, SRS relies on the transmission in uplink (UL) of known symbols to each of four receive antennas. By receiving each of these known transmissions from each antenna, the gNodeB base station can develop an accurate channel model for the RF path from each of the antennas back to the gNodeB. Additionally, with respect to downlink (DL), the reciprocal nature of the UL and DL in TDD enables a much better transfer function for each of the antenna RF channel models, and the SNR can be significantly improved for both higher order MIMO as well as higher order receive (Rx) diversity.

Although SRS provides a number of benefits, SRS can interfere with certain features, such as carrier aggregation and/or EN-DC connectivity.

Radio Frequency Front-End with 3-8 GHz Support and High-Order Downlink MIMO/Diversity

According to certain embodiments, radio frequency front-ends are provided herein that achieve a high level of integration and re-use, with a relatively low count of antennas, power amplifiers, low noise amplifiers, filters, switches, and modules. For example, certain embodiments cover some or all of UHB (e.g., n77 [e.g., 3300-4200 MHz], n79 [e.g., 4400-5000 MHz], and all sub-bands), 5-7 GHz WiFi, ultra-wideband (UWB2) (e.g., 7125-8400 MHz), n104 (e.g., 6425-7125 MHz), and FR3 (e.g., 7125-8400 MHz). Some such configurations include one or more of the following: 2-4 modules, 6-8 antennas, co-banding of FR3 and n104 power amplifiers, co-banding of FR3 and n104 low noise amplifiers, optimal multiplexer count and efficient multiplexing, minimal cascading of switches in performance critical locations (e.g., UWB2 and 5th-6th receive paths of FR3 and n104), and a high level of co-existence (e.g., limited only by transceiver and baseband capabilities).

Moreover, certain embodiments achieve one or more of: minimizing or reducing power amplifier and low noise amplifier count by co-banding, achieving efficient co-banding, allowing efficient co-banding and antenna/route re-use by splitting WiFi into U-NII 1-3 and U-NII 5-8, multiplexing UHB with n104 and/or FR3 for enhanced co-existence with fewer antennas and components, enabling UEs that deploy 6G FR3 to obtain n104 operation, supporting SRS-AS signaling in all cellular bands with minimal overhead and fully utilizing the benefits of massive MIMO, enabling diplexer tunability/switchability to enhance co-existence support (e.g., between n104 and UWB2 without sacrificing full-grade FR3 or n104 operation when UWB2 is inactive).

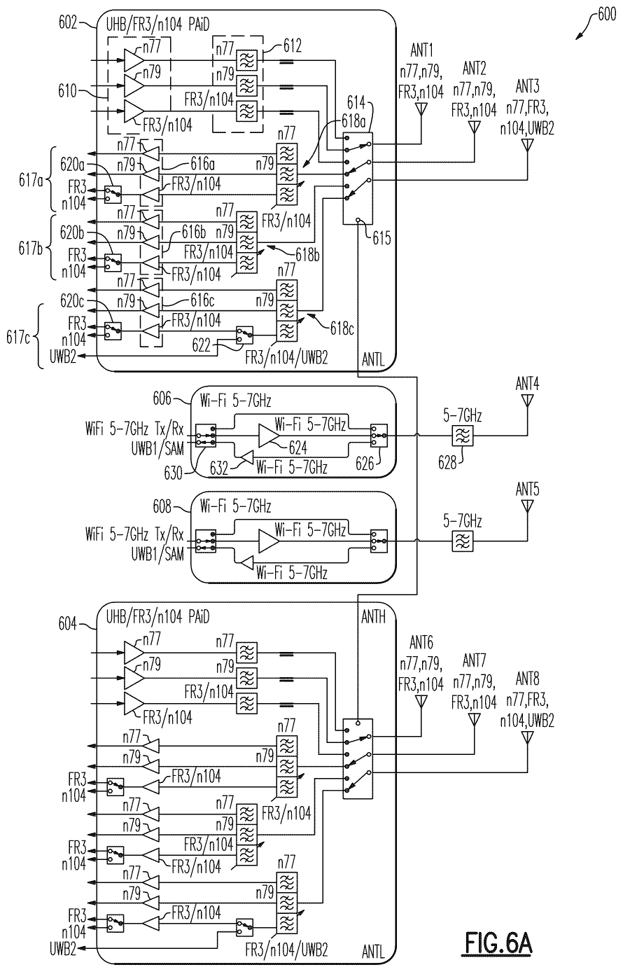

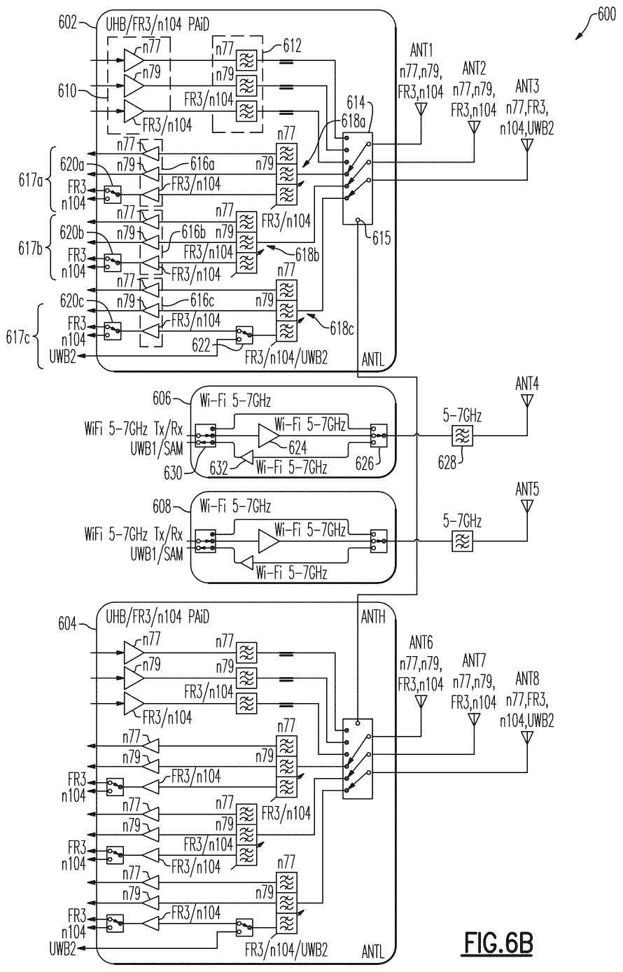

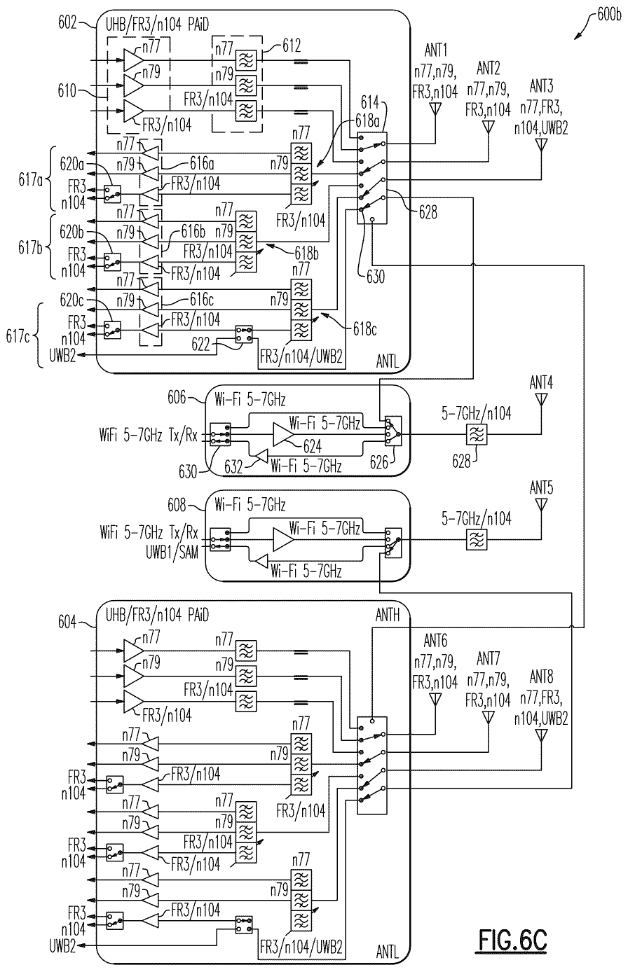

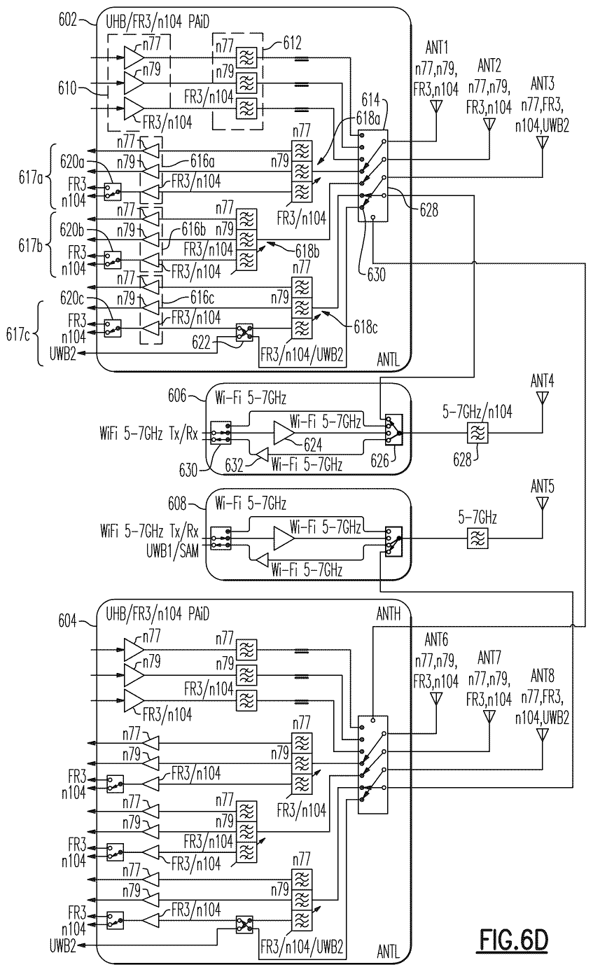

FIG. 6A is a schematic diagram of a front-end system 600 in accordance with certain embodiments. The front-end system 600 has four modules including a first power amplifier integrated duplexer (PAID) 602 connected to three antennas ANT1, ANT2, ANT3, a second power amplifier integrated duplexer (PAID) 604 connected to three antennas ANT6, ANT7, ANT8, a first Wi-Fi module 606 connected to antenna ANT4, and a second Wi-Fi module 608 connected to antenna ANT5. The first and second PAiDs 602, 604 of the illustrated system can be capable of both transmitting and receiving in at least n77, n79, FR3, and n104, and at least receiving in UWB2.

As shown, the first and second PAiDs 602, 604 each include three transmit paths. Each transmit path includes one of the transmit power amplifiers 610 connected via a respective one of the transmit filters 612 and an antenna switch module 614 to three antennas (ANT1-ANT3 for the PAiD 602 and ANT6-ANT8 for the PAiD 604). The three transmit amplifiers 610 are configured for transmitting n77 (top amplifier), n79 (middle amplifier), and FR3/n104 (bottom amplifier), respectively, and the three corresponding filters can be configured to pass n77 (top filter), n79 (middle filter) and FR3/n104 (bottom filter). The transmit amplifiers 610 can be GaAs power amplifiers according to some embodiments although other types of amplifiers can be used. The antenna switch module 614 is configurable to selectively transmit the output of any of the three transmit filters 612 on any of the three antennas. The antenna switch module 614 can be a silicon-on-insulator (SOI) switch manufactured using an SOI process, although other types of semiconductor switches are possible.

The first and second PAiDs 602, 604 further each include three sets of receive paths 617a, 617b, 617c. Each individual receive path includes a receive amplifier in one of the sets of receive amplifiers 616a, 616b, 616c, which is connected via a respective band filter included in one of the triplexers 618a, 618b, 618c. Each triplexer 618a, 618b, 618c combines its three input receive paths to a common output connection, and provides the common output connection to a port of the antenna switch 614.

The transmit filters 612 and receive filters 616a, 616b, 616c can be acoustic filters according to some embodiments (e.g., surface acoustic wave [SAW] or bulk acoustic wave [BAW] filters). The individual transmit filters in the group of transmit filters 612 can each comprise a separately packaged device (e.g., surface mount device [SMD]), and each triplexer 618a, 618b, 618c can comprise three ganged together filters contained in a common packaged triplexer SMD or other packaged device.

The antenna switch module 614 can be configured to connect the combined output of each triplexer 618a, 618b, 618c to a selected antenna ANT1, ANT2, ANT3. The illustrated antenna switch module 614 can be a 4P6T (4 pole, 6 throw) switch, for example. In some embodiments, the antenna switch module 614 can be configured for switch-combining or switch-plexing multiple throw ports of the switch to a single antenna port, e.g., for certain carrier aggregation (CA) modes.

The three receive amplifiers in each set of receive amplifiers 616a, 616b, 616c are configured to amplify n77 (top), n79 (middle), and FR3/n104 (bottom). The FR3/n104 filter can be selectively configurable (e.g., frequency tunable) to pass FR3 or n104 depending on the mode of operation. The FR3/n104 receive path in each set of receive paths additionally includes a corresponding band-select switch 620a, 620b, 620c configured to select between an FR3 output and an n104 output depending on the active receive band.

In the illustrated embodiment, the bottom set of receive paths is similar to the top two sets of receive paths, except that the bottom set is additionally configured to selectively receive UWB2, and thus includes an additional band-select switch 622 between the FR3/n104 receive amplifier in the bottom set of receive amplifiers 616c and the tunable FR3/n104/UWB2 filter in the bottom triplexer 618c. The band select switch 622 is configured to select either the UWB2 path or the FR3/n104 receive path. Moreover, the FR3/n104/UWB2 receive filter in the bottom set of receive paths 617c can be configured (e.g., frequency tunable) to pass any of FR3, n104, or UWB2 depending on the mode of operation.

As shown, the antenna switch modules 614 of the first PAiD 602 and the second PAiD 604 can be connected to one another via the ANTL and ANTH ports, e.g., via a cross-UE cable, thereby allowing for sharing of antennas or other communication between the first and second PAiD modules 602, 604. Thus, the antenna switch 614 of the first PAiD 602 can be configured to connect one of the antennas ANT1-ANT3 to the port 615 of the switch 614, thereby connecting that antenna to the ANTL port of the first PAiD 602 and thus to the ANTH port of the second PAiD 604. This can allow for Rx channel data to be communicated from one of the antennas ANT1-ANT3 of the first PAiD 602 to receive paths within the second PAiD 604, or for transmit data to be communicated from a transmit path within the second PAiD 604 to the first PAiD 602 for transmission via one of the antennas ANT1-ANT3. The antenna switch 614 can additionally be configurable to connect the port 615 to any one of the six throws of the switch 614, thereby allowing communication of Rx channel data from one of the antennas ANT6-ANT8 of the second PAiD 604 to receive paths within the first PAiD 602 or communication of Tx channel data from the first PAiD 602 to the second PAiD 604 for transmission via one of the antennas ANT6-ANT8.

As shown, the first and second Wi-Fi modules 606, 608 can each include a power amplifier 624 for transmitting and a receive amplifier 632 for receiving WiFi 5-7 GHz. The transmit amplifier 624 and the receive amplifier 632 of each module 606, 608 are connected to the respective antenna (ANT4 for the first Wi-Fi module 606 and ANT5 for the second Wi-Fi module 608) via a switch 626 connected to a filter 628, which can be a bi-directional filter, e.g., for TDD transmit and receive. Moreover, each Wi-Fi module 606, 608 includes a switch 630 configured to selectively provide transmit signals to the transmit amplifier 624 and to receive the output of the receive amplifier 632. The switches 630, 626 can additionally include a bypass path for bypassing the amplifiers during transmit and/or receive, depending on the operating mode.

Any of the illustrated filters can be acoustic filters for example, such bulk acoustic wave (BAW) or surface acoustic wave (SAW) filters each comprising a set of piezoelectric resonators.

The front-end system of FIG. 6A can have some or all of the following features:
Dedicated transmit and receive filters for cellular in the first and second PAiDs 602, 604.
WiFi/FR3 concurrency (e.g., using some hot-spot/channel-selection @7 GHz).
WiFi/UWB2 concurrency.
n104/UWB2 concurrency (e.g., partial n104 4 Rx+UWB2, with bottom receive paths 617c receiving in UWB2 and top and middle receive paths 617a, 617b receiving in n104).
n77/FR3 CA 6 Rx=(e.g., assuming no UWB2 during FR3).
n77/n104 CA 6 Rx=(e.g., assuming no UWB2), or 6 Rx+4 Rx+UWB2 (e.g., 6 Rx n77+4 Rx n104+UWB2).
n79 and all n79 carrier aggregation modes (e.g., with n77, n104, FR3) also support 6 Rx potentially (can optionally not include the third copy of n79 filter+LNA [e.g., in third set of receive paths 617c] if 6 Rx not desired for n79 [e.g., 4 Rx only]).
Downgrade option for UHB to 1T (single transmit) (DSM) (e.g., by excluding the FR/n104 amplifier and filter in the second PAiD 604).
FR3 and n104 are 2 Tx (two transmit).
Can also support n78 Tx+n104 Rx or vice-versa (simultaneous Tx/Rx mode) with 4×4 RX on each band. Similarly, can support n79 Tx+n104 Rx or vice-versa.
6G band 4.4-4.8 GHz supported within n79 path.

Thus, the radio frequency front-end system 600 can be flexibly configured in a wide variety of different manners depending on the desired operating mode.

As indicated by the configurations of the antenna switch 614 and the receive switches 620a, 620b, 620c, 622, in FIG. 6A, the first and second PAiDs 602, 604 may be configured for n79 transmission on antennas ANT1, ANT6 and n77, n79, FR3 reception on at least antennas ANT2, ANT3, ANT7, and ANT8. The passbands of the tunable FR3/n104 filter in each of the top and middle triplexers 618a, 618b and of the tunable FR3/n104/UWB2 filter in the bottom triplexer 618c can each be tuned to pass FR3 in the illustrated configuration. For instance, in such a configuration, the radio frequency front-end system 600 can operate in 2 Tx in n79 (one Tx channel on ANT1, and another on ANT6) and at least 4 Rx in n77, n79, and FR3 (one n77, n79, FR3 Rx channel on each of the top and bottom groups of receive paths 617a, 617c in each PAiD 602, 604). Moreover, in some configurations, while not shown in FIG. 6A, the antenna switch 614 may switch-combine or switch-plex the n79 transmit path and the output of the middle triplexer 618b, connecting both to ANT1 (PAiD 602) and ANT6 (PAiD 604). In such a case, the front-end system 600 can achieve 2 Tx in n79, 4 Rx in n79, and 6 Rx in n77 and FR3, with the switch-combining gaining an additional receive path for n77 and FR3 in each PAiD 602, 604 from ANT1 (PAiD 602) and ANT6 (PAiD 604) through the middle group 617b of receive paths. In such a case, n79 may not be received by the n79 path in the middle group 617b of receive paths because n79 is transmitting on ANT1 and may therefore not be able to also receive n79 on ANT1.

FIG. 6B illustrates another configuration of the radio frequency system 600 in a receive-only mode. As indicated by the configurations of the antenna switches 614 and the receive switches 620a, 620b, 620c, 622, in FIG. 6B, the first and second PAiDs 602, 604 are configured for n77, n79, and FR3 reception on antennas ANT1, ANT2, ANT3, ANT6, ANT7, and ANT8. Similar to the configuration of FIG. 6A, the passbands of the tunable FR3/n104 filter in each of the top and middle triplexers 618a, 618b and of the tunable FR3/n104/UWB2 filter in the bottom triplexer 618c can be tuned to pass FR3. Thus, in FIG. 6B, the radio frequency system 600 is operating with 6 Rx in bands n77, n79, and FR3.

FIG. 6C shows a schematic diagram of another embodiment of a radio frequency system 600b. The front-end system 600b of FIG. 6C may be like that of the front-end system 600 of 6A except that, unlike the system of FIG. 6A, the system 600b of FIG. 6C includes a connection between the antenna switch module 614 of the first PAiD 602 and the switch 626 of the first Wi-Fi module 606, and a connection between the antenna switch module 614 of the second PAiD 604 and the switch 626 of the second Wi-Fi module 608, e.g., via cross-UE cables, thereby allowing for some routing of cellular connection (e.g., n104) through the WiFi antennas ANT4, ANT5 to the first and second PAiDs 602, 604 (e.g., n104 Rx), respectively, and/or from the PAiDs 602, 604 to the WiFi modules 606, 608 (e.g., n104 Tx).

As shown, the antenna switch 614 of each of the PAiDs 602, 604 of the system 600b of FIG. 6C can be modified as compared to that of the system 600 of FIG. 6A to include an additional pole and an additional throw to be a 4P7T (5 pole, 7 throw) switch, with the additional pole 628 accommodating the connection to the respective WiFi module 606, 608, and the additional throw 630 accommodating an additional receive path that bypasses the bottom triplexer 618c. Moreover, the band switch 622 can be modified to include an additional pole and additional path. In addition, the filter 628 of the first and second WiFi modules 606, 608 can be modified to include an additional throw to accommodate the connection to the respective PAiD 602, 604.

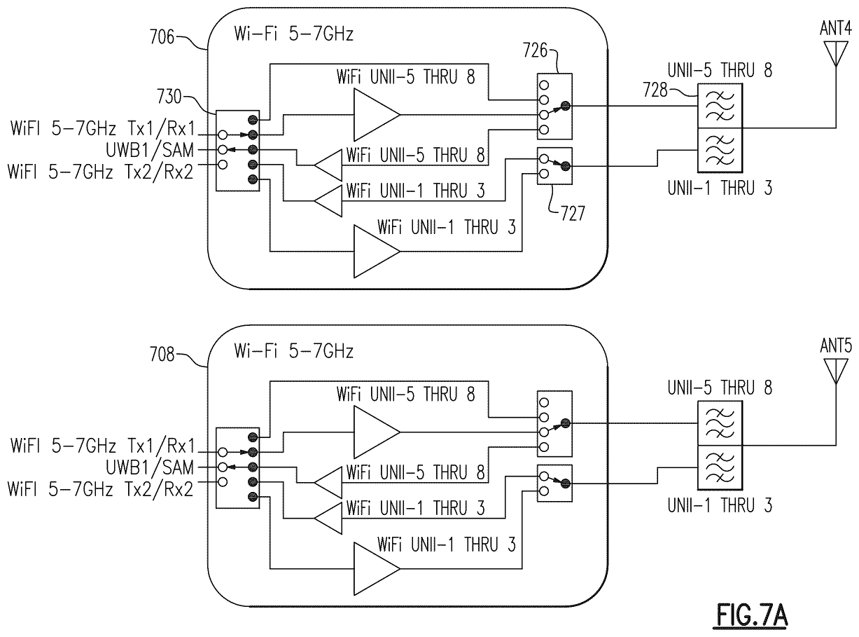

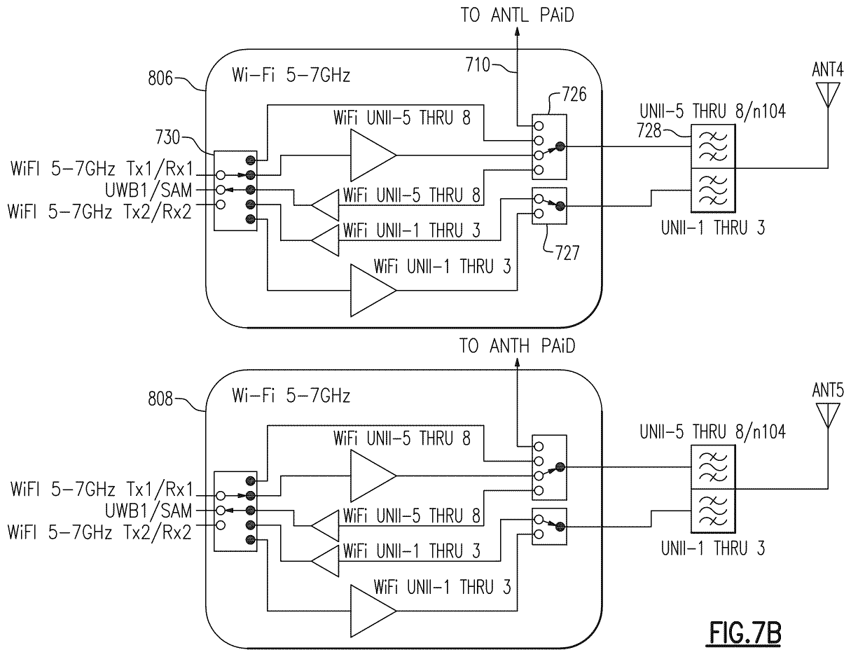

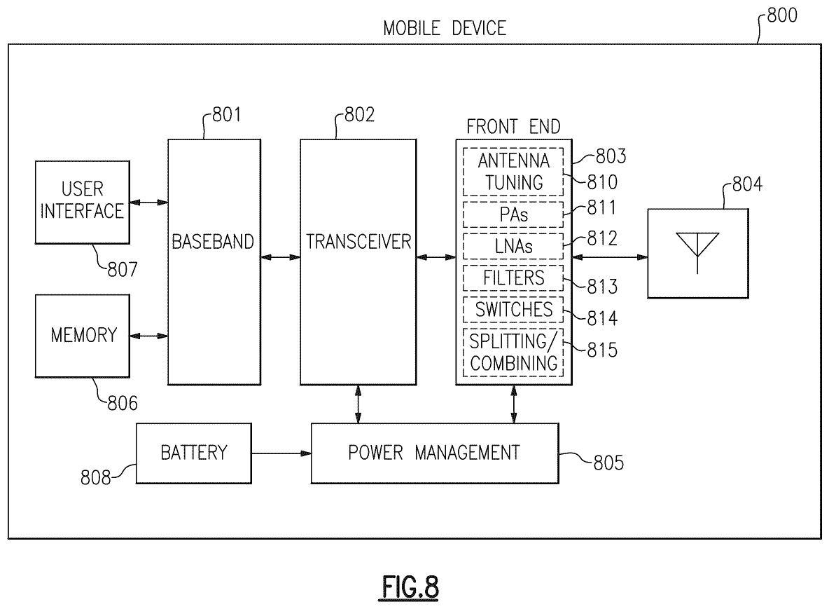

FIG. 6C illustrates an example of achieving increased cellular Rx throughput by exploiting the connection between the WiFi modules 606, 608 and the PAID modules 602, 604. As indicated by the switch states of the antenna switches 614 and receive switches 620a, 620b, 620c, and 622, in FIG. 6C the front-end system 600b may be configured for 2 Tx n79 (on antennas ANT1 and ANT6), and n77, n79, n104 Rx on antennas ANT2, ANT3, ANT7, and ANT8. Moreover, two additional n104 Rx channels can be added via the first WiFi module 606 from ANT4 to the first PAiD module 602 and via the second WiFi module 608 from the ANT5 to the second PAiD module 604. The passbands of the tunable FR3/n104 filter in each of the top and middle triplexers 618a, 618b and of the tunable FR3/n104/UWB2 filter in the bottom triplexer 618c can each be tuned to pass n104. Thus, in the configuration of FIG. 7C, the front-end system 600b can achieve 2 Tx n79, 4 Rx n77 and n79, and 6 Rx n104. In some embodiments, the switch 614 can switch-combine the output of the middle triplexer 618b with the n79 transmit path to connect both to ANT1 (PAiD 602) and ANT 6 (PAiD 604), providing two additional n77 and n104 Rx channels. Moreover, depending on the implementation, the Wi-Fi modules 606, 608 may also be configured for concurrent Wi-Fi operation while transmitting or receiving n104.

FIG. 6D illustrates another configuration of the radio frequency system 600b in a receive-only mode with UWB2 and n104 concurrency. As indicated by the configurations of the antenna switches 614 and the receive switches 620a, 620b, 620c, 622, in FIG. 6D, the first and second PAiDs 602, 604 are configured for n77, n79, and n104 reception on antennas ANT1, ANT2, ANT6, and ANT7. Thus, the passbands of the tunable FR3/n104 filter in each of the top and middle triplexers 618a, 618b can each be tuned to pass n104. The first and second PAiDs 602, 604 are further configured for n77, n79, and UWB2 reception on antennas ANT3 and ANT8. Thus, the passbands of the tunable FR3/n104/UWB2 filter in the bottom triplexer 618c can each be tuned to pass UWB2. Moreover, the first and second PAiDs 602, 604 are configured to receive n104 on antennas ANT4, ANT5 via the inter-module connections. As shown, the switch 622 is configured to pass the UWB2 output of the FR3/n104/UWB2 filter (tuned to UWB2) to the UWB2 output of PAiDs 602, 604, and to pass the n104 channel, which has been filtered by the filters 628 of the respective WiFi modules 606, 608, to the FR3/N104 amplifier for output to the switch 620c. Thus, the radio frequency system 600b in FIG. 6C may be operating in 6 Rx in bands n77, n79, and n104 and 2 Rx in band UWB2. Moreover, depending on the implementation, the Wi-Fi modules 606, 608 may also be configured for concurrent Wi-Fi operation while transmitting or receiving n104.

While n104 support via the WiFi modules 606, 608 of FIGS. 6C-6D has been discussed in the context of n104 receive, in some embodiments, the WiFi modules 606, 608 can be configured to support additional n104 transmit capability, e.g., via connection by the antennas switches 614 of n104 transmit paths in the PAiDs 602, 604 to the WiFi modules 606, 608.

The front-end system 600b of FIGS. 6C and 6D can be configured for some or all of the following features:
Cellular routing through WiFi antenna (n104), via the interconnection between the PAiD 602 and the Wi-Fi module 606 and the PAiD 604 and the Wi-Fi module 608.
Dedicated transmit and receive filters for cellular in the first and second PAiDs 602, 604.
WiFi/FR3 concurrency (e.g., using hot-spot/channel-selection @7 GHz)
WiFi/UWB2 concurrency.
n104/UWB2 concurrency.
n77/FR3 CA 6RX (e.g., assuming no UWB2 during FR3).
n77/n104 CA 6RX (e.g., 6 Rx+6 Rx+UWB2).
n79 and all n79 carrier aggregation modes (e.g., with n77, n104, FR3) also supporting 6 Rx potentially (can remove 3rd copy of n79 filter+LNA if 6 Rx not desired).
Downgrade option for UHB to 1 Tx (DSM) (e.g., do not include Tx FR3/n104 amplifier or FR3/n104 Tx filter in the second PAiD 604).
FR3 & n104 are 2 Tx (two transmit).
Support n78 Tx+n104 Rx or vice-versa (simultaneous Tx/Rx mode) with 4×4 Rx on each band. Similarly for n79T+n104 Rx or vice-versa.
6G band 4.4-4.8 GHz already supported within n79 path.

FIG. 7A is a schematic diagram of alternative Wi-Fi modules 706, 708, which may be incorporated into the front-end system 600 of FIG. 6A-6B in place of the Wi-Fi modules 606, 608 in accordance with certain embodiments. As shown, the first and second Wi-Fi modules 706, 708 are configured for Wi-Fi (UNII 1-3)/WiFi (UNII 5-8) concurrency, and can each include a first power amplifier for transmitting WiFi UNII-1 thru 3, and a second power amplifier for transmitting WiFi UNII-5 thru 8, a first receive amplifier for receiving WiFi UNII-1 thru 3, and a second receive amplifier for receiving WiFi UNII-5 thru 8. The WiFi UNII-5 thru 8 transmit and receive amplifiers of each module 706, 708 are connected to the respective antenna ANT4, ANT5 via a first antenna switch 726 and a UNII-5 thru 8 filter 728, which can be configured as a bi-directional filter. The WiFi UNII-1 thru 3 transmit and receive amplifiers of each module 706, 708 are connected to the respective antenna ANT4, ANT5 via a second antenna switch 727 and a UNII-1 thru 3 filter 729, which can be configured as a bi-directional filter, and ganged together with the UNII-5 thru 8 filter 728 filter. Moreover, each Wi-Fi module 706, 708 includes a transmit receive switch 730 configured to selectively connect appropriate transmit signals to the transmit amplifiers and to connect appropriate receive ports to the outputs of the receive amplifiers. As shown, the Wi-Fi modules 706, 708 can additionally include a bypass path for bypassing the amplifiers, depending on the operating mode.

The illustrated filters can be acoustic filters for example, such bulk acoustic wave (BAW) or surface acoustic wave (SAW) filters each comprising a set of piezoelectric resonators.

A front-end system such as the front-end system 600 of FIGS. 6A-6B incorporating the Wi-Fi modules 706, 708 of FIG. 7A can have some or all of the following features:
dedicated transmit filters and dedicated receive filters for cellular operation in the first and second PAiD modules 702, 704.
No sharing of connections or interconnect between the cellular and Wi-Fi paths.
WiFi (UNII 1-3)/WiFi (UNII 5-8) concurrency.
WiFi/FR3 concurrency (e.g., using hot-spot/channel-selection @7 GHz).
WiFi/UWB2 concurrency.
n104/UWB2 concurrency.
n77/FR3 carrier aggregation 6RX=YES (assuming no UWB2 during FR3)
n77/n104 carrier aggregation 6RX=YES (assuming no UWB2), OR 6RX+4RX+UWB2 possible.
n79 and all n79 CA modes (with n77, n104, FR3) also support 6RX (& remove 3rd copy of n79 filter+LNA if not desired).
Downgrade option for UHB to 1T (DSM).
Can also support n78T+n104R or vice-versa (simultaneous Tx/Rx mode) with 4×4 RX on each band, and for n79T+n104R or vice-versa.
6G band 4.4-4.8 GHz already supported within n79 path.

FIG. 7B shows a schematic diagram of alternative Wi-Fi modules 806, 808, which may be incorporated into the front-end system 600b of FIG. 6C-6D in place of the Wi-Fi modules 606, 608 in accordance with certain embodiments. The Wi-Fi modules 806, 808, unlike the Wi-Fi modules 706, 708 of FIG. 7A, the Wi-Fi modules 806, 808 of FIG. 7B each include a connection 710 to the antenna switch module 614 of the first and second PAiDs 602, 604. Moreover, the filters 728 of each of the Wi-Fi modules 806, 808 have been modified to accommodate n10⁴ cellular support. Thus, the Wi-Fi modules 806, 808 allow for some routing of cellular connection (e.g., n104) through the WiFi antenna and/or vice versa, like the Wi-Fi modules 606, 608 of FIGS. 6C-6D.

A front-end system such as the front-end system 600b of FIGS. 6C-6D incorporating the Wi-Fi modules 806, 808 of FIG. 7B can be configured for some or all of the following features:
Cellular routing through WiFi antenna (n104) via the connection between the PAID 702 and the W-Fi module 706.
Dedicated transmit filters and receive filters for cellular operation in the PAiDs 702, 704.
WiFi (UNII 1-3)/WiFi (UNII 5-8) concurrency.
WiFi/FR3 concurrency (using some hot-spot/channel-selection @7 GHz).
WiFi/UWB2 concurrency.
n104/UWB2 concurrency (n104 6RX+UWB2).
n77/FR3 CA 6RX=YES (assuming no UWB2 during FR3).
n77/n104 CA 6RX=YES (6RX+6RX+UWB2).
n79 and all n79 carrier aggregation modes (with n77, n104, FR3) also support 6RX potentially (& remove 3rd copy of n79 filter+LNA if not).
Downgrade option for UHB to 1T (DSM).
FR3 & n104 are 2T.
Can also support n78T+n104R or vice-versa (simultaneous Tx/Rx mode) with 4×4 RX on each band. Similarly for n79T+n104R or vice-versa.
Upcoming 6G band 4.4-4.8 GHz already supported within n79 path.

Although the front-end systems of FIGS. 6A, 6B, 7A, and 7B illustrate examples of the front-end systems, the front-end systems can be modified in a wide variety of ways, e.g., to support additional bands.

FIG. 8 is a schematic diagram of one embodiment of a mobile device 800. The mobile device 800 includes a baseband system 801, a transceiver 802, a front-end system 803, antennas 804, a power management system 805, a memory 806, a user interface 807, and a battery 808.

The mobile device 800 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 8 as the transceiver 802. In one example, separate components (for instance, separate circuits or dies) can be provided for handling certain types of RF signals.

The front-end system 803 aids in conditioning signals transmitted to and/or received from the antennas 804. The front-end system can be any of the front-end systems described herein, including any of those shown and described with respect to FIGS. 6A-6D, 7A, and 7B. In the illustrated embodiment, the front-end system 803 includes antenna tuning circuitry 810, power amplifiers (PAS) 811, low noise amplifiers (LNAs) 812, filters 813, switches 814, and signal splitting/combining circuitry 815. However, other implementations are possible.

For example, the front-end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards. In certain implementations, the antennas 804 support MIMO

communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 800 can operate with beamforming in certain implementations. For example, the front-end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 8, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 8, the power management system 805 receives a battery voltage from the battery 808. The battery 808 can be any suitable battery for use in the mobile device 800, including, for example, a lithium-ion battery.

Table 1 below lists example frequency ranges for certain 3GPP (e.g., LTE, 5G, Wi-Fi) bands that have been discussed herein:

TABLE 1

| Band | Frequency range | Duplex |
|---|---|---|
| n77 | 3300-4200 MHZ | TDD |
| n78 | 3300-3800 MHz | TDD |
| n79 | 4400-5000 MHz | TDD |
| n104 | 6425-7125 MHz | TDD |
| FR3 | 7125-8400 MHZ | TDD |
| | (or 7125-24000 MHz | |
| | in some embodiments) | |
| UWB2 | 7125-8400 MHZ | N/A |
| | | (pulse-based) |
| Wi-Fi UNII-1 | 5150-5250 MHz | TDD |
| Wi-Fi UNII-2 | 5250-5350 MHz | TDD |
| | (UNII-2A) | |
| Wi-Fi UNII-3 | 5725-5850 MHz | TDD |
| Wi-Fi UNII-5 | 5925-6425 MHz | TDD |
| Wi-Fi UNII-6 | 6425-6525 MHz | TDD |
| Wi-Fi UNII-7 | 6525-6875 MHz | TDD |
| Wi-Fi UNII-8 | 6875-7125 MHz | TDD |

### Applications

Some of the embodiments described above have provided examples in connection with mobile devices. However, the principles and advantages of the embodiments can be used for a wide range of RF communication systems. Examples of such RF communication systems include, but are not limited to, mobile phones, tablets, base stations, network access points, customer-premises equipment (CPE), laptops, and wearable electronics.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A radio frequency front-end system comprising:
a first module and a second module each configured to provide radio frequency communication paths including at least one transmit path for each of a first band, a second band, and a third band, and at least three receive paths for each of the first band, the second band, and the third band, the first module and the second module each further including at least three antenna ports, an antenna switch connected between the radio frequency communication paths and the at least three antenna ports, and at least three multiplexers each configured to split a corresponding combined receive signal provided by the antenna switch into separate receive signals for the first band, the second band, and the third band;
first, second, and third antennas connected to the at least three antenna ports of the first module; and
fourth, fifth, and sixth antennas connected to the at least three antenna ports of the second module.

2. The radio frequency front-end system of claim 1 wherein the first band, the second band, and the third band are time division duplex bands.

3. The radio frequency front-end system of claim 1 wherein each of the at least three multiplexers is a separately packaged device.

4. The radio frequency front-end system of claim 3 wherein each of the at least three multiplexers is a triplexer.

5. The radio frequency front-end system of claim 3 wherein each of the at least three multiplexers includes one or more acoustic filters.

6. The radio frequency front-end system of claim 1 further comprising a third module and a fourth module each configured to provide at least one transmit path and at least one receive path for at least a fourth band, a seventh antenna connected to the third module, and an eighth antenna connected to the fourth module.

7. The radio frequency front-end system of claim 6 wherein the first band, the second band, and the third band are wide area network (WAN) bands, and the fourth band is a local area network (LAN) band.

8. The radio frequency front-end system of claim 7 wherein the first band, the second band, and the third band are cellular bands n77, n79, and n104, and the fourth band is a WiFi band.

9. The radio frequency front-end system of claim 6 wherein the first module, the second module, the third module, and the fourth module are separately packaged modules.

10. The radio frequency front-end system of claim 6 wherein the first module and the second module are each configured to provide at least one transmit path and at least three receive paths for each of the first band, the second band, the third band, and a fifth band, the at least one transmit path for the third band and the fifth band being shared, and the at least three receive paths for the third band and fifth band being shared.

11. The radio frequency front-end system of claim 10 wherein the first module and the second module are further configured to provide at least one receive path for a sixth band.

12. The radio frequency front-end system of claim 11 wherein the first band, the second band, third band, and the fifth band are cellular bands, and the sixth band is an ultra-wideband.

13. The radio frequency front-end system of claim 11 wherein the third module is coupled to the first module, and further configurable to route a signal received in the third band to the first module, and the fourth module is coupled to the second module, and further configurable to route a signal received in the third band to the second module.

14. The radio frequency front-end system of claim 6 wherein the third module is coupled to the first module, and further configurable to route a signal received in the third band to the first module, and the fourth module is coupled to the second module, and further configurable to route a signal received in the third band to the second module.

15. A radio frequency front-end module comprising:
radio frequency communication paths including at least one transmit path for each of a first band, a second band, and a third band, and at least three receive paths for each of the first band, the second band, and the third band;
at least three antenna ports;
an antenna switch connected between the radio frequency communication paths and the at least three antenna ports; and
at least three multiplexers each configured to split a corresponding combined receive signal provided by the antenna switch into separate receive signals for the first band, the second band, and the third band.

16. The radio frequency front-end module of claim 15 wherein the radio frequency front-end module is a multi-chip module contained in a module packaging.

17. The radio frequency front-end module of claim 15 wherein each of the at least three multiplexers is a separately packaged device.

18. The radio frequency front-end module of claim 15 wherein each of the at least three multiplexers is a triplexer including one or more acoustic filters.

19. The radio frequency front-end module of claim 15 wherein the first band, the second band, and the third band are wide area network (WAN) bands.

20. A mobile device comprising:
a transceiver;
a radio frequency front-end including a first module and a second module each configured to provide radio frequency communication paths including at least one transmit path for each of a first band, a second band, and a third band, and at least three receive paths for each of the first band, the second band, and the third band, the first module and the second module each further including at least three antenna ports, an antenna switch connected between the radio frequency communication paths and the at least three antenna ports, and at least three multiplexers each configured to split a corresponding combined receive signal provided by the antenna switch into separate receive signals for the first band, the second band, and the third band;
first, second, and third antennas connected to the at least three antenna ports of the first module; and
fourth, fifth, and sixth antennas connected to the at least three antenna ports of the second module.
